(19) United States
(12) Patent Application Publication
(10) Pub. No.: US 2010/0103035 A1
(43) Pub. Date: Apr. 29, 2010

(54) Player identification and geographical positioning device, for online games and equivalents

(75) Inventor: Raul Eugenlo Daneri, Buenos Aires (AR)

Correspondence Address: MEREK, BLACKMON & VOORHEES, LLC, 673 S. WASHINGTON ST, ALEXANDRIA, VA, 22314, US

(73) Assignee: GRUPO AYEX S.A.

(21) Appl. No.: 12/588,510

(22) Filed: Oct. 19, 2009

(30) Foreign Application Priority Data
Oct. 29, 2008 (AR) P-2008 0104713

(51) Int. Cl. G01S 1/00

(52) U.S. Cl. 342/357.06

(57) ABSTRACT

A device having electronics with general management logic, a GPS antenna and its management electronics, a GSM antenna and its management electronics, a USB connector and its driver, and an RS-232 connector similar to a Pen Drive both in external aspect and size. It generates an electronic signature that identifies the device univocally. It provides the geographical location of the device through a GPS and a GSM antenna.

### INVENTION FIELD

This invention patent refers to innovative player identification and geographical positioning device, which shall have the technical name “GPS/GSM Player Pen”, pertaining to the field of media, resources and accessories adequate for online games, be it trivia games or other games of chance and entertainment. It may also be applied on electronic and electro-mechanic machines used at Gambling Rooms of Bingos and Casinos.

This invention defines a new combination of means designed to achieve a superior result, therefore, it is rendered unpredictable and surprising even for an expert in the field. Consequently, besides being a new invention, its construction and functional conception evidences a clear inventive activity, in such a way that it meets the conditions required by Law to be considered an invention patent.

### PRIOR ART

Within the context of a growing online game activity, there arose the need to establish a specific and single legal framework in the international agenda.

In effect, the specific characteristics of online gambling generate a series of complex problems, in addition to the natural problems resulting from the sector's regulation.

Online game management companies receive the main criticism from the traditional Lottery Agencies. They accuse the former unfair competition since they get a highly superior operating field with fewer costs and with no special tax requirements demanded.

Similarly, the organization of games and events of this kind is being the object of special analysis by control organizations since there exist no effective “system” capable of controlling tax contributions.

One of the jurisdictional problems this activity encounters results from the fact that the legal domicile of the Gambling Management Company tends to fail to coincide with the domicile wherefrom the latter are controlled and managed.

On the other hand, the Management Company could be licensed to take bets from clients who live in areas where certain types of gambling are prohibited, thus hindering tax payment and collections.

As indicated hereinbefore, a truly unfair situation is thus posed towards other activities, where both the companies and their Clients are to undertake tax burdens related to the geographical origin of each transaction and also to their destination.

Therefore, these inconveniences are a direct result from not having resources or means capable of verifying the origin of each transaction in a reliable way and, furthermost, the geographical region from where the transaction was originated.

### DESCRIPTION OF THE INVENTION

The Player Identification and Geographical Positioning Device referred to herein this invention patent has been specially designed so that, with the use of such device, the geographical location of each client when the latter is about to participate in the game, may be speedily determined, and therefore the corresponding restrictions, under the laws and regulations in effect in such region, shall be applied.

The invented identification device comprises an innovative technological means capable of rapidly finding and reporting both the client's geographical location -so that the corresponding restrictions may be applied before authorization of bets- and each event to the Authorities responsible for gambling supervision and control in real time.

The invented identification device provides the following functional advantages, namely:
Identification and localization, in a trustworthy manner, of clients about to participate in the game before their placing a bet.
Geographical location of the client, combining GPS (Global Positioning System) technology, used to determine an object's position worldwide with a few-meter accuracy, and GSM (Global System for Mobile Communications) technology, used to calculate an object's position by means of triangulation of different service provider cells.
On the other hand, it guarantees the univocal identification of the device by means of using the electronic signature mechanism. Thus, information security and integrity aspects are clearly met, as well as the authenticity of the message's origin and the non rejection by issuer.
Moreover, since the invention provides a univocal identification means, it can be applied to game rooms in Bingo and Casinos (EGMs) as a means to identify gamblers in various systems such as those usually called “Cashless” or “Player Tracking”.

In order to put into practice the aforementioned object and advantages, the player identification and geographical positioning device referred to herein this invention patent is constituted as of electronics with a general management logic, a GPS antenna and its management electronics, a GSM antenna and its management electronics, a first connector, such as a USB connector, and its driver, and a second connector, such as an RS-232 connector.

The invented device may have an external aspect of varied configuration in a size similar to that of a Pen Drive.

### INVENTIVE ACTIVITY

No person identification resource currently known proposes or even suggests the construction solution that the aforementioned paragraphs describe. Hence, this proposal is not only innovative but it also evidences a clear inventive activity.

### BRIEF DESCRIPTION OF FIGURES

In order to summarize both the advantages referred to herein and the further advantages users and experts on the field may add, and also to facilitate the understanding of the construction, constitutive and functional features of the invented device, a preferred embodiment of implementation is described hereinafter which is illustrated, schematically and with no specific scale, in the plates attached. It is hereby expressly stated that, being precisely an embodiment, no limit or exclusivity to the scope of protection of this invention patent shall be allocated; on the contrary, the sole aim is to explain and illustrate the basic concept this invention is based upon.

FIG. 1 is a construction and functional diagram that represents the invented device in its basic means combination.

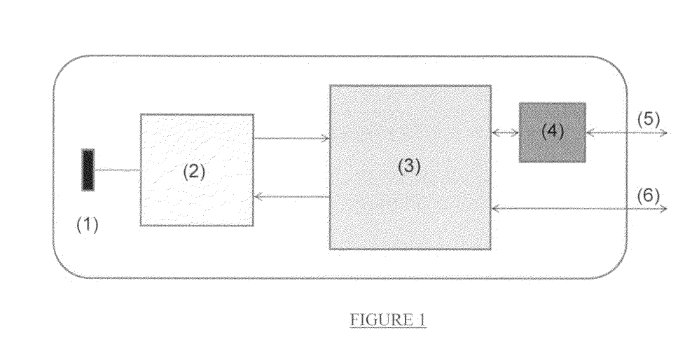

### DESCRIPTION OF AN IMPLEMENTATION EMBODIMENT

As previously indicated, the invented identification and positioning device has an external forming similar to a Pen Drive in appearance and size, which bears a USB connector for the connection to (5) a PC that enables the access to an online game, and an RS-232 connector (6) to be connected to an EGM device of gambling in rooms.

Internally, the invented device comprises a GPS antenna (1) with its electronic installation (2) used for its operation, the USB port driver (4) (USB LC8 2P6), the main electronics (3) (ARM7) with the device's logic and a GSM antenna (7) with its electronic installation (8) used for its operation.

It is hereby specially stated that no illustration or description of the electronic installation (2-8) referred hereto are displayed, and neither is the aforementioned main electronics (3) since they are commonly known in the field of expertise.

The invention refers to the combination of means determined to achieve an efficient application in the control and management of online bets, trivia and equivalent online gambling.

Therefore, a built-in Chip Antenna shall be used which advantage lies on being the smallest in the market and on having a reception capacity that fails to depend on the position of the antenna in respect to the ground plane (it need not be in vertical position, as opposed to other models).

Although such antenna (1) fails to have the precision of other types of antenna, it fully meets the invention requirements.

The invented device resorts to the use of an authorizing electronic signature, of the type that identifies the device univocally, thus it may be used as an identification means both for gambling in rooms and for online gambling.

The afore mentioned clearly evidences that through the GPS antenna (1) the geographical location of the device is provided in order to restrict gambling to specific areas and obtain information for commercial analysis as well.

Moreover, through the GSM antenna (7) the geographical location of the device is provided in areas where GPS technology (2) is out of range, for instance, within confined spaces. The GPS antenna (2) finds the last known location of the device. Then, through the GSM antenna (7), by conducting a triangulation with the different service provider cells it has access to, it verifies the location shows no variation when the first antenna is out of range.

With regards to information security, it is stressed that the electronic signature mechanism meets the aforementioned security aspects, information integrity, authenticity of the message's origin and non rejection by issuer.

Should it be preferred, a symmetric algorithm shall be used to achieve greater security in communications.

In terms of physical security, the external frame is tampered; therefore, when opened, the device stops working permanently.

In addition, the memory is built in the main electronics, in such a way that the program is protected against non-authorized copies.

The access procedure of a player to an online gambling site is as follows:
There will be an initiation process of the device prior to the gambling, through which a digital certificate and the public and private passwords necessary for the electronic signature shall be stored. User shall be required to create a personal password for accessing betting sites.
Whenever player accesses to an online betting site, there will be a Sign In function to the betting system. When signing in, the site will control the invented device is inserted in a USB port of the user's computer.
If the device is found, an SSL (Secure Socket Layer) connection shall begin, based on the exchange of public and private passwords between the device and the site and the use of electronic signatures (this is a standard procedure in the Web; therefore no details are provided herein).
In addition, user will be requested to enter a personal password.
Should the connection be accepted by the site, in other words, should both the personal password and the electronic signature be correct, the device shall inform the current geographical location obtained through GPS and GSM technologies.
This site will validate that the location be accepted according to the player's contractual conditions when purchasing the device.
Should location be correct, player shall be allowed to begin betting.

Having described and determined the nature and scope of this invention and the way it shall be executed, it is hereby stated that what is claimed to be an invention and of exclusive property is as follows:

1. A player identification and geographical location device, for online games and equivalents, designed to speedily determine the geographical location of each client when willing to participate in a game, so that corresponding restrictions, related to the laws and regulations of such region, may be applied, comprising a module made up of electronics with general management logic, a GPS antenna and its management electronics, a GSM antenna and its management electronics, a USB connector and its driver, and an RS-232 connector combined.

2. The player identification and geographical location device according to claim 1, wherein the device has an external appearance similar to a Pen Drive both in configuration and size.

3. The player identification and geographical location device according to claim 1, wherein the device receives an authorization resulting from an electronic signature that identifies the device univocally.

4. The player identification and geographical location device according to claim 1, wherein the geographical location of the device is provided through a GPS antenna and a GSM antenna.
